(19) United States
(12) Patent Application Publication
(10) Pub. No.: US 2004/0241310 A1
(43) Pub. Date: Dec. 2, 2004

(54) Method of producing antibodies ex-vivo

(76) Inventors: Sveibjorn Gizurarson, Reykjavik (SE); Jann Hau, Uppsala (SE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/486,874

(22) PCT Filed: Aug. 16, 2002
(86) PCT No.: PCT/DK02/00539

(30) Foreign Application Priority Data
Aug. 16, 2001 (IS) 6051

(51) Int. Cl. A23D 7/00

(52) U.S. Cl. 426/607

(57) ABSTRACT

A pharmaceutical composition to be administered to avian species, especially poultry, either into the drinking water or into the diet or to be aerosolised over the hens, consisting of a vehicle system comprising a mono-/di-, ester-/etherglycerides conjugated with water-soluble polymer groups selected from PEG's containing 2-30 polyoxyethylene units, an antigen and optionally a bacterial toxin, preferably CTB, are useful for the production of antibodies in egg yolk. The conjugated glycerides are able to augment the production of antibodies ex-vivo in egg yolk, minimizing animal stress and invasive procedures.

### BACKGROUND OF THE INVENTION

The present invention relates to a novel non-invasive procedure in avian species such as poultry, in particular hens, for the augmentation of the antibody production in egg yolk by administrating an antigen together with an adjuvant to mucosal membranes (oral respiratory, ocular and otal membranes) of the species in question.

Invasive procedures e.g. administration by way of intramuscular, intradermal or subcutaneous injections of antigens or vaccines to animals such as hens using various adjuvants such as Freunds incomplete adjuvant, is normally regarded as the way of production of polyclonal antibodies. However, such injections present a range of disadvantages. They require the use of sterile syringes and may cause animal stress, pain and irritation, particularly in the case of repeated injections, including the risk of infection—or may be poorly tolerated. More significantly in the case of intramuscular injections there is likely to be indurations (hardening of tissue), haemorrhage (bleeding) and/or abscess formation and/or necrosis (local death of tissue) at the injection site, especially after the use of irritating adjuvants. Besides, untrained or unlicensed persons may not administer injections to animals.

U.S. Pat. No. 5,753,228 discloses a method for augmenting the antibody production in egg yolk, by administering the antigens subcutaneously to the hens using Freunds Complete Adjuvant, a substance causing severe pain and illness in animals. U.S. Pat. No. 6,143,559 also discloses a method for raising antibodies by injecting the antigens to the hens.

Mucosal administration of antigens in poultry such as hens is currently receiving special interest, since this route may avoid the inconveniences caused by the direct intervention into the organism in connection with parenteral administration, resulting in stress, haemorrhage or even psychological trauma during repeated injections etc.

Furthermore, this route of administration may conveniently be used since untrained and unlicensed persons are allowed to perform it.

Mucosal administration of antigens has been attempted in poultry such as hens using different adjuvants, orally, via the respiratory tract as well as through other mucosal surfaces. The elicitation of a local immune response through mucosal surfaces of such antigens cannot be considered unexpected in such cases, because the mucosa is naturally invaded by pathogens, creating immunity through a sub-clinical infection. However, the augmentation of systemic antibody production in egg yolk is difficult, since subunit proteins, purified antigens and vaccines are poor inducers of homing responses to the eggs and do therefore require an effective formulation and adjuvant in order to produce antibodies in eggs.

It is therefore necessary to administer the antigens in the form of a suitable pharmaceutical composition. Depending on the chemical property of the antigen it may be necessary to consider different aspects in order to develop a composition for use in raising antibodies in poultry.

The potential use of various vehicles as drug delivery systems for mucosal administration has been discussed in the literature. When using such vehicle systems, the antigens as well as the excipients may be rapidly absorbed into the blood stream. Some of the problems encountered in using many vehicle systems are related to the fact that the excipients may be absorbed and therefore need to be biocompatible and biodegradable. Hence there is a need for providing an antigenic composition containing an adjuvant system that can be administered safely to poultry without causing the animals any form of harm and at the same time augment the antibody production in egg yolk.

WO 99/02186 discloses a pharmaceutical composition comprising antigens and adjuvant comprising ethoxylated mono and/or diglycerides for immunisation of humans. The pharmaceutical composition is also stated to be useful for a great number of animals in order to elicit an appropriate immune response to resist or eliminate a certain pathogen. Hence, the composition is useful for preventing or treating a given illness in animals. There is no suggestion of using similar compositions for the manufacture of antibodies in poultry on an industrial scale.

U.S. Pat. No. 4,349,540 discloses antigenic preparations comprising peptidoglycans as well as polyoxyethylated oleic glycerides, where it is stated that the peptidoglycans is used as an adjuvant, hence the polyoxyethylated oleic glycerides serves as a solubilising agent in the composition.

It has now surprisingly been found that a vehicle system comprising mono-/di-, ester-/etherglycerides conjugated with water-soluble polymer groups selected from polyethylene glycols (PEG's) containing 2-30 polyoxyethylene units or mixtures thereof and an antigen provides a significant antibody production in egg yolk, especially polyclonal antibodies, without causing the animal stress or pain due to a non-invasive administration procedure. At the same time the system according to the invention is environment-friendly.

Thus, the primary object of the invention is to provide a method and a composition for the administration of antigens to a mucosal surface in avian species, especially poultry such as hens without causing stress to the animal, resulting in large amount of immunospecific antibodies produced in egg yolk.

It is another object of the invention to provide a delivery system for mucosal application in poultry, where the delivery system is based on natural materials and therefore environment-friendly.

### A DETAILED DESCRIPTION OF THE INVENTION

The present invention relates to the use of one or more mono-/di-, ester-/etherglycerides of formula (I):

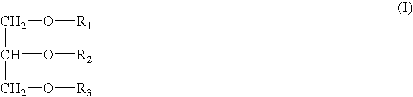

where R₁, R₂ and R₃ are either one or two C₆₋₂₄ residues of saturated or unsaturated fatty acids or alcohols and the remaining group/groups are water soluble polymer groups selected from PEG₂₋₃₀ residues of polyoxyethylene as an adjuvant in a physiologically acceptable composition containing an antigen for mucosal administration in avian species in order to raise polyclonal antibodies in avian egg yolk.

The invention also relates to a method for raising polyclonal antibodies in avian egg yolk which comprises administering to an avian species, in particular poultry via the mucosal route one or more mono-/di-, ester-/etherglycerides according to formula I as an adjuvant in a physiologically acceptable composition containing an antigen.

Examples of the chemical structure of the adjuvant used according to the invention is shown in (II)-(V) where the water soluble polymer group is a PEG₃₋₆ (PEG containing 3-6 residues of polyoxyethylene), i.e. —(OCH₂CH₂)₃₋₆—OH

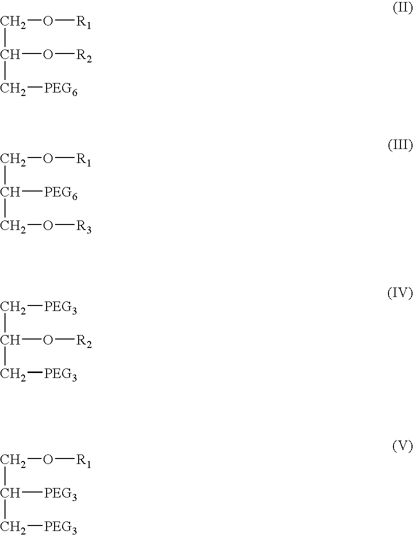

where R₁, R₂ and R₃ are C₆₋₂₄ residues of saturated or unsaturated fatty acids or alcohols, preferably saturated C₈₋₁₈ residues and more preferably saturated C₈₋₁₄ residues. In a preferred embodiment R₁ and R₂ are saturated C₆₋₁₈ alcohol residues and more preferably saturated C₈₋₁₂ alcohol residues.

The PEG₂₋₃₀ residues of polyoxyethylene, or derivatives thereof, have 2-30 polyoxyethylene units and more preferably 3-6 polyoxyethylene units.

The concentration of the glycerides exemplified by (II)-(V) in the composition may vary from 0.01% to 30%. The ratio between mono- and di- glycerides may vary from 0.1%:99.9% to 99.9%:0.1%, preferably from 5%:95% to 95%:5%. The chiral carbon in the glyceride may be in either S— or R-form. The ratio between ester- and etherglycerides may vary from 0:100% to 100:0%, preferably 0:100% or 100:0%. More preferably the composition contains only mono-/di-fatty acid glycerides (esterglycerides). The difference between ether- and esterglycerides is shown better in VI (etherglyceride) and VII (esterglyceride):

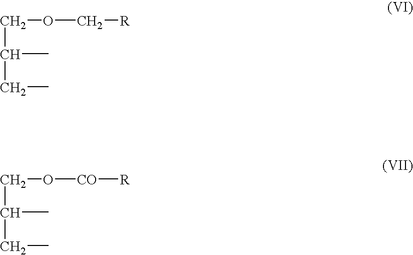

The concentration of the mono-/di-, ester-/etherglycerides may be in the range of 0.01 to 30% w/w, preferably from 0.5 to 20% and more preferably from 1 to 15%.

The composition may further comprise a bacterial toxin or a derivative or subunit thereof. Preferably the toxin is cholera toxin and more preferably cholera toxin B subunit B (CTB). The addition of a toxin to the composition results in an improved yield of the formed antibodies.

The composition according to the invention may be a suspension, an emulsion or a dispersion providing the adjuvant in admixture with a dispersing or wetting agent, suspending agent, and/or one or more preservatives. Such compositions should be suitable for use on a mucosa such as the gastrointestinal, buccal, nasal, rectal, eye, respiratory, or vaginal mucosa. Suitable dispersing or wetting agents are, for example, naturally occurring phosphatides, e.g., lecithin, or soybean lecithin; condensation products of ethylene oxide with e.g. a fatty acid, a long chain aliphatic alcohol, or a partial ester derived from fatty acids and a hexitol or a hexitol anhydride, for example polyoxyethylene stearate, polyoxyethylene sorbitol monooleate, polyoxyethylene sorbitan monooleate etc. Suitable suspending agents are, e.g., naturally occurring gums such as, e.g., gum acacia, xanthan gum, or gum tragacanth; celluloses such as, e.g., sodium carboxymethylcellulose, microcrystalline cellulose (e.g. Avicel® RC 591, methylcellulose; alginates such as, e.g., sodium alginate, etc. Suitable examples of preservatives for use in compositions used according to the invention are parabens, such as methyl or propyl p-hydroxybenzoate, and benzalkonium chloride.

For application to the buccal, oral, otal eye or nasal mucosa the composition may be administered as sprays or aerosols for inhalation. In a typically buccal/oral or nasal composition, the antigen is present in the form of a particulate composition optionally dispersed in a suitable vehicle. The pharmaceutically acceptable vehicles and excipients and optionally other pharmaceutically acceptable materials present in the composition such as diluents, enhancers, flavouring agents, preservatives etc. are all selected in accordance with conventional pharmaceutical practice in a manner understood by the persons skilled in the art of formulating pharmaceuticals. After administration of a composition used according to the invention, the antigen may be taken up by the nearest lymphoid tissue. The adsorption to the mucosa is believed to lead to a less irritative effect than when e.g. a liquid vehicle e.g. containing a penetration enhancer or promoter is employed.

For application to the oral mucosa, the compositions used according to the invention may contain conventionally non-toxic pharmaceutically acceptable carriers and excipients including microspheres and liposomes. The pharmaceutically acceptable excipients may include emulsifying agents, antioxidants, buffering agents, preservatives, humectants, chelating agents, or gelforming agents.

Examples of emulsifying agents are naturally occurring gums, e.g. gum acacia or gum tragacanth, naturally occurring phosphatides, e.g. soybean lecithin, and sorbitan monooleate derivatives. Examples of antioxidants are ascorbic acid and cysteine. Examples of preservatives are parabens, such as methyl or propyl p-hydroxybenzoate, and benzalkoniun chloride. Examples of humectants are glycerin, propylene glycol, and sorbitol, The formulations mentioned above are suitable for introduction into relevant orifice(s) of the body, e.g. the nasal, eye, pulmonal, buccal, rectal, urethral, vaginal or oral orifices. The composition may simply be applied directly on the the mucosa.

Many mucosal compositions need some specialised mixture of excipients. Therefore many compositions may comprise one or more surfactants and/or water absorbing polymers and/or substances which inhibit enzymatic degradation and/or alcohols, pH-controlling agents, solubilizers, stabilisers, HLB-controlling agents, viscosity controlling agents, osmotic pressure controlling agents, water and mixtures thereof. The surfactants may be selected from nonoxynol, octoxynol, tweens, spans, sodium lauryl sufate, sorbitan monopalmitate; water absorbing polymers may be selected from glycofurols and derivatives thereof, polyethyleneglycol 200-7500 and derivatives thereof, polyvinylpyrrolidone; polyacrylic acid, propyleneglycol, gelatine, cellulose and derivatives thereof, substances which inhibit enzymatic degradation may be selected from aprotinin, DFP, carbopol; pH-controlling agents may be selected from acetic acid, hydrochloric acid, nitric acid, potassium metaphosphate, potassium phosphate, sodium acetate, ammonia, sodium carbonate, sodium hydroxide, sodium borate, trolamine; solubilizers may be selected from alcohol, isopropyl alcohol, water, glycofurol, polyethyleneglycole 200-7500; stabilisers such as cyclodextrines; HLB controlling agents may be selected from Tween 20-85, Span 20-80, Brij 30-98, acacia; viscosity controlling agents may be selected from cellulose and derivatives thereof, Tweens and derivatives thereof, polyethyleneglycole and derivatives thereof, cetyl alcohol, glycerine, propylene glycol, sorbitol, gelatina; osmotic pressure controlling agents may be selected from dextose, sodium chloride, mannitol;

The antigen employed in the composition used according to the invention should be suitable for augmenting the antibody production in egg yolk. The antigen may be a protein, drug or an enzyme (for diagnostic purpose, for analytical production such as for RIA, ELISA etc.), a vaccine such as vaccine against bacterial, viral, fungal, prion, or parasitic infections, components produced by micro-organisms such as IgA-proteases, Protein p38, Protein p43 or mucinase. The antigen may also be an allergen such as house dust mite, cat allergen, rye grass pollen, short ragweed pollen, midge, egg white, milk protein, bee venom etc. or components responsible for inducing autoimmune diseases such as myelin, insulin peptide B etc. The antigen may also be a disease antigen such as cancer antigens. Suitable antibodies that may be produced using the technique according to the invention are specific antibodies for the treatment of a number of cancers, for the treatment of Alzheimers disease (anti-amyloid antibodies), for the treatment of viral diseases such as anti-cytomegalovirus or anti-HTLV or anti-RSV antibodies, for the treatment of parasites such as anti-malaria antibodies. Antibodies are harvested from the egg yolk employing conventional protein purification procedures known for the isolation of immunoglobulins; for example, gel filtration, ion-exchange chromatography or other techniques known to the person skilled in the art. The antibodies may also be identified using techniques known to the person skilled in the art, as an example, the harvesting of the antibodies and the use of ELISA for the identification of antibodies is described in U.S. Pat. No. 6,143,559.

The antigen may be used in a particulate form or a dissolved form. The composition is especially suitable to dissolved antigens; however, it is also easy to disperse a particulate form of the antigen in the composition.

The composition used according to the invention is especially suitable for administration to hens. The nature of the formulation provides the possibility to influence the immune response in various directions and therefore the composition may also be used in hens at various ages. The composition used according to the invention is also very suitable for other avian species such as, turkey, goose, ostrich, duck or wild birds.

A composition may be administered to variety of mucosal surfaces such as the mucosa of the nose, lungs, mouth, eye, ear, gastrointestinal tract, vagina, rectum, where the mucosa of the eye, nose and mouth are very suitable for this composition. In such cases the composition should be administered as spray, drops or added to the drinking water or to the diet.

### EXAMPLE I

Hens are given orally 100 μL composition, containing 1.5 μg (a) human IgG; (b) cholera toxin B subunit and (c) Basic myelin protein in following compositions: (I) Isotonic saline (comparison); (II) 5% “Softigen 767” a PEGylated C8/C10 mono-/diglycerides, containing 6 polyoxyethylene (PEG₆) units, (sold by Condea Chemie AG) in isotonic saline (according to the invention) and compared with (III) intraperitoneal (ip) injection in FIA (Freunds Incomplete Adjuvant) according to the prior art . Four weeks after the first vaccination, the hens received a booster containing the same vaccines. After the booster, the eggs are collected and the antibodies in the egg yolk isolated and their concentration determined. The results for composition a) containing human IgG were as follows (antibody concentration in egg yolk):

(a) Saline: 0 AU/ml

(b) Softigen: 70.000 AU/ml

(c) Freunds adjuvant given ip: 90.000 ml AU/ml.

It appears that a high antibody titer of the order of magnitude as obtained by ip injection is obtained with the adjuvant used according to the invention.

### EXAMPLE II

A total of 18 outbred White Leghorn chickens (20 weeks old, line 36, Swedish University of Agricultural Sciences) were used in the study. They were housed at Löfsta-Funbo (Swedish University of Agricultural Sciences, Uppsala, Sweden) in single cages with 8 hours dark and 16 hours lighting. Food (produced at Löfsta-Funbo, (10)) and tap water was available ad lib. The temperature was 18-23° C. and the ventilation was controlled (humidity not measured). The weight of the chickens was 1361 g (±160) at the start of the experiment. Throughout the immunization program, eggs were collected and marked individually and after 10 months the hens were exsanguinated during anaesthesia (Metomidat 20 mg/kg im+Diazepam 2.5 mg/kg iv). The test groups consisted of two hens in each group. All the hens were immunised by oral gavage, except the positive control group, and received 100 μg human IgG together with one of the following adjuvants. After administration of the antigen/adjuvant mixture, 1 ml saline was administered by gavage.

Group A: received poly(D, L-lactide-co-glycolide) (PLG) microspheres, (62.5 mg/ml) made by a double emulsion (water in oil in water) procedure and administered on days 1 and 14 at a dose of 1 ml/chicken.

Group B: received PLG (6.25 mg/ml) suspended in 1 ml PBS and administered at a dose of 1 ml/chicken on days 1, 2, 3 and 17.

Group C: received Cholera toxin B-subunit (CTB) mixed 10:1 (molar ratio CTB:IgG) in saline and administered (dose: 200 μl) on days 1, 14 and 33.

Group D: received Cholera toxin B-subunit (CTB) mixed 3:1 (molar ratio CTB:IgG) in saline and administered (dose: 200 μl) on days 1, 14 and 33.

Group E: received Cholera toxin B-subunit (CTB) conjugated with glutaraldehyd and IgG 10:1 After dialysed against PBS over night in room temperature, the mixture was administered at a dose of 200 μl on days 1, 14 and 33.

Group F: received Cholera toxin B-subunit (CTB) conjugated 3:1: CTB and IgG were conjugated (3:1) with glutaraldehyde as described above. The mixture was administered at a dose of 200 μl on days 1, 14 and 33.

Group G: received Dimethyl dioctadecyl ammonium bromide (DDA): 500 μg DDA and 100 μg IgG were dissolved in 200 μl saline and mixed (dose: 200 μl/chicken) at days 1, 14 and 33.

Group H(according to the invention): received Softigen© (Condea Chemie Gmbh, Witten Germany) in a concentration of 1:20 (v:v) in a IgG solution (1 mg/ml in saline). The dose was 200 μl/chicken, which was administered on days 1, 19 and 46.

Positive control group: Two hens were immunised subcutaneously with 100 μg human IgG (Sigma, Stockholm, Sweden) in 100 μl saline (0.9% NaCl) emulsified with an equal volume of FIA (Freund's Incomplete Adjuvant, Sigma, Stockholm, Sweden) on days 1, 14, and 33.

Negative control group: 83 chickens from line 36 were used as a reference group concerning egg laying frequency, egg weight and body weight.

The purification of the immunoglobulins (IgY) from egg yolk was performed as briefly described here below: The egg yolk was separated from the white by an egg separator. The yolk was washed with distilled water to remove unwanted egg white. The vitteline membrane was punctured and the yolk was collected in 50 ml Falcon tubes (Sarstedt, Landskrona, Sweden). The volume was measured (called original volume) and diluted 1:10 (v:v) in distilled water. The mixture was frozen at −20° C. until further purification. The mixture was thawed out in room temperature, chloroform was added 1:50 (v:v), mixed and centrifuged (45 min, 1800 g, 4° C.), The supernatant was collected and concentrated in a dialysis tube (MWCO 12-14000) in PEG 6000 to less than the original volume. The yolk solution was transferred to a 14 ml Falcon tube (Sarstedt, Landskrona, Sweden) and the volume was adjusted to the original volume. Ammonium sulphate (AmS) was added to 50% saturation and the mixture was left over night at 4° C. with gentle stirring. The solution was centrifuged (45 min, 1800 g, 4° C.) and the pellet was dissolved in 1 ml distilled water and sodium azide added to a concentration of 0.05%. The IgY-solution was stored at 4° C. until analysis.

Results: One of four chickens in the CTB-group showed high titers and both chickens in the Softigen group (according to the invention)showed high titers. The animals in the DDA and PLG-microsphere groups showed no or very low titers.

### EXAMPLE III

Hens are given human IgG antigens in 5% Softigen 767 (PEG-C8/C10 glycerides), in isotonic saline. The composition is administered (I) 5 μL intranasally; (II) 100 μL orally into the mucosa of the mouth, (III) 100 μL as a spray above the hens directed to the head; (IV) 5 μL rectally; and (V) 5 μL dermally. Four weeks after the first vaccination, the hens received a booster containing the same vaccines. One week later, eggs were collected and the antibodies isolated from the egg-yolk.

1. Use of mono-/di-, ester-/etherglycerides of formula (I): 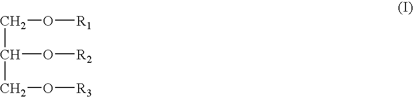
where either one or two of R₁, R₂ and R₃ are C₆₋₂₄ residues of saturated or unsaturated fatty acids or alcohols and the remaining group/groups are water soluble polymer groups selected from polyethyleneglycols (PEG's) containing 2-30 residues of polyoxyethylene or mixtures thereof as an adjuvant in a physiologically acceptable composition containing an antigen for non-invasive mucosal administration in avian species in order to produce polyclonal antibodies in avian egg yolk.

2. Use of a composition according to claim 1, wherein one or two of R₁, R₂, and R₃ are selected from saturated C₆₋₁₈ alcohol residues, preferably C₈₋₁₂ alcohol residues.

3. Use of a composition according to claim 1, wherein the water soluble polymer groups consist of PEG₂₋₃₀ residues of polyoxyethylene having 2-30 polyoxyethylene unites, preferably having 3-6 polyoxyethylene units.

4. Use of a composition according to claim 1, wherein the PEG substituted glycerides, or the mixture thereof, has a concentration of from about 0.01% to about 30%, preferably of from about 0.5 to about 20%, more preferably of from about 0.5 to about 5% by weight.

5. Use of a composition according to claim 1, wherein the composition further comprises a bacterial toxin or a derivative or subunit thereof.

6. Use of a composition according to claim 5, wherein the bacterial toxin is cholera toxin or a derivative or subunit thereof, preferably cholera toxin B-subunut (CTB).

7. Use of a composition according to claim 1, where the antigen is a protein, cell component, drug or other substances where specific antigens are advantageous, for the production of antibodies for the treatment or prophylactic treatment of diseases.

8. Use of a composition according to claim 1, wherein the antigen is in a dissolved form.

9. Use of a composition according to claim 1, wherein the antigen is in a dissolved form.

10. Use of a composition according to claim 1, said composition further comprising one or more components selected from the group consisting of: surfactants, absorption promoters, water absorbing polymers, substances which inhibit enzymatic degradation, alcohols, organic solvents, oils, pH-controlling agents, solubilizers, stabilizers, HLB-controlling agents, viscosity controlling agents, preservatives, osmotic pressure controlling agents, propellants, air displacement, water, and mixtures thereof.

11. Use of a composition according to claim 1 for administration in poultry such as hens, turkeys, geese, ostriches, ducks or other birds.

12. Use of a composition according to claim 1 for the manufacture of polyclonal antibodies usable for treatment of humans.

13. Use of a composition according to claim 1 for the manufacture of polyclonal antibodies usable for diagnostic or analytical purpose.

14. Use of a composition according to claim 1, wherein the administration is through a mucosal surface, selected from the group of mucosa surfaces of the nose, lungs, mouth, eye, ear, gastrointestinal tract, genital tract, vagina, or rectum, preferably through the buccal, oral, nasal and eye mucosa.

15. Use of a composition according to claim 14 where the composition is administered orally, administered into the drinking water or food, or sprayed onto the avian species where the spray is directed towards the head of the species.

16. Use of a composition according to claim 1, wherein the antigen and the composition comprising the adjuvant are administered sequentially.

17. A method for producing polyclonal antibodies in avian yolk comprising administering to an avian species, in particular poulty, via the mucosal route in a non-invasive manner one or more PEG-conjugated mono-/di-, ester-/etherglycerides as an adjuvant in a physiologically acceptable composition containing an antigen and separating the polyclonal antibodies from the egg yolk.
